(19) United States
(12) Patent Application Publication
(10) Pub. No.: US 2024/0272121 A1
(43) Pub. Date: Aug. 15, 2024

(54) AUTOMATED OPTIMIZATION OF DIFFERENTIAL MOBILITY SPECTROMETRY (DMS) SEPARATIONS USING ALPHA FUNCTIONS

(71) Applicant: DH Technologies Development Pte. Ltd., Singapore (SG)

(72) Inventors: Bradley B. SCHNEIDER, Bradford (CA); Leigh BEDFORD, Whitby (CA); Yves LE BLANC, Newmarket (CA); Eva DUCHOSLAV, Toronto (CA)

(73) Assignee: DH Technologies Development Pte. Ltd., Singapore (SG)

(21) Appl. No.: 18/569,701

(22) PCT Filed: Jun. 16, 2022
(86) PCT No.: PCT/IB2022/055615

§ 371 Date: Dec. 13, 2023

Related U.S. Application Data
(60) Provisional application No. 63/211,895, filed on Jun. 17, 2021.

(51) Int. Cl. G01N 27/623; G01N 27/624; H01J 49/00

(52) U.S. Cl. CPC G01N 27/623; G01N 27/624; H01J 49/0031

(57) ABSTRACT

An automated method of operating a mass spectrometer (MS) comprising a differential mobility spectrometer (DMS) includes: introducing a first compound to the DMS; calculating a first alpha function for the first compound; introducing a second compound to the DMS; calculating a second alpha function for the second compound; and determining operation parameters of the DMS to achieve sufficient separation of the first compound and the second compound, based on the first alpha function and the second alpha function.

### CROSS-REFERENCE TO RELATED APPLICATION

The application is being filed on Jun. 16, 2022, as a PCT International Patent Application that claims priority to and the benefit of U.S. Provisional Application No. 63/211,895 filed on Jun. 17, 2021, which application is hereby incorporated herein by reference.

### BACKGROUND

Differential Mobility Spectrometers (DMS), also referred to as a Field Asymmetric Waveform Ion Mobility Spectrometers (FAIMS) or Field Ion Spectrometers (FIS), typically perform gas-phase ion sample separation and analysis by continuously transmitting ions-of-interest while filtering out unwanted species. In some circumstances, a DMS can be interfaced with a mass spectrometer (MS) to take advantage of the atmospheric pressure, gas-phase, and continuous ion separation capabilities of the DMS and the detection accuracy of the MS. By interfacing a DMS with an MS, numerous areas of sample analysis, including proteomics, peptide/protein conformation, pharmacokinetics, and metabolism analysis have been enhanced. In addition to pharmaceutical and biotech applications, DMS-based analyzers have been used for trace level explosives detection and petroleum monitoring. As a result, there is significant interest in optimizing DMS parameters to ensure that the best possible separation is achieved.

### SUMMARY

In one aspect, the technology relates to an automated method of operating a mass spectrometer (MS) comprising a differential mobility spectrometer (DMS). The automated method includes: introducing a first compound to the DMS; calculating a first alpha function for the first compound; introducing a second compound to the DMS; calculating a second alpha function for the second compound; and determining operation parameters of the DMS to achieve sufficient separation of the first compound and the second compound, based on the first alpha function and the second alpha function.

In another aspect, the technology relates to another automated method of operating a MS comprising a DMS. The method includes: analyzing a first compound; analyzing a second compound; and determining operation parameters of the DMS to achieve sufficient separation of the first compound and the second compound, based on the first mathematical function and the second mathematical function.

Analyzing the first compound further includes: introducing the first compound to the DMS at each of a plurality of separation voltages (SVs); while introducing the first compound at each of the plurality of SVs, adjusting a compensation voltage (CoV) of the DMS; while adjusting the CoVs for each of the plurality of SVs, concurrently monitoring an analytical signal from the MS; based at least in part on monitoring the analytical signal, identifying a CoV optimum for each of the plurality of SVs; and generating a first mathematical function based at least in part on the CoV optimum for each of the plurality of SVs, wherein the first mathematical function has an input comprising a SV-related parameter and a value comprising a CoV-related parameter.

Analyzing the second compound further includes: introducing the second compound to the DMS at each of a plurality of separation voltages (SVs); while introducing the second compound at each of the plurality of SVs, adjusting a compensation voltage (CoV) of the DMS; while adjusting the CoVs for each of the plurality of SVs, concurrently monitoring an analytical signal from the MS; based at least in part on monitoring the analytical signal, identifying a CoV optimum for each of the plurality of SVs; and generating a second mathematical function based at least in part on the CoV optimum for each of the plurality of SVs, wherein the second mathematical function has an input comprising the SV-related parameter and a value comprising the CoV-related parameter.

In another aspect, the technology relates to yet another automated method of operating a MS comprising a DMS. The method includes: introducing a first compound to the DMS; calculating a first alpha function for the first compound; introducing a second compound to the DMS; calculating a second alpha function for the second compound; introducing a third compound to the DMS; calculating a third alpha function for the third compound; subtracting the first alpha function from the second alpha function to determine a first difference function; subtracting the first alpha function from the third alpha function to determine a second difference function; subtracting the second alpha function from the third alpha function to determine a third difference function; identifying a threshold alpha function difference; and determining a separation field value such that an absolute value of the first difference function, an absolute value of the second difference function, and an absolute value of the third difference function are equal to or greater than the threshold alpha function difference. It should be noted that other aspects extend these teachings to any number of compounds of interest.

In yet another aspect, the technology relates to an automated method of operating a MS comprising a DMS. The method includes: introducing a plurality of compounds to the DMS; calculating a plurality of alpha functions corresponding to the plurality of compounds; identifying a threshold alpha function difference; and determining a range of separation field based on the plurality of alpha functions and the threshold alpha function difference.

In yet another aspect, the technology relates to an automated method of operating a MS comprising a DMS. The method includes: accessing an alpha function library to retrieve a first alpha function for a first compound and a second alpha function for a second compound; and determining operation parameters of the DMS to achieve sufficient separation of the first compound and the second compound, based on the first alpha function and the second alpha function.

### BRIEF DESCRIPTION OF THE DRAWINGS

FIG. 1 depicts the structures of three isobaric species.

FIG. 2 depicts a schematic view of an automated differential mobility spectrometer and mass spectrometer (DMS-MS) system in accordance with some aspects of the disclosure.

FIG. 3 is a schematic diagram of the differential mobility spectrometer (DMS) of FIG. 2.

FIG. 4 depicts alpha curves for two isomers, namely pentobarbital and amobarbital.

FIG. 5 depicts a difference curve between the pentobarbital alpha curve and the amobarbital alpha curve of FIG. 4.

FIG. 6 depicts the separation of amobarbital and pentobarbital.

FIG. 7 is a flowchart diagram illustrating a separation method.

FIG. 8 depicts a graphic overlay of a series of compensation voltage (CoV) ramps that are acquired at a series of different separation voltage (SV) values.

FIG. 9 is a flowchart diagram illustrating a separation method.

FIG. 10 is a flowchart diagram illustrating the operation 902 or 904 of FIG. 9.

FIG. 11 depicts a graphic overlay of three alpha curves of three compounds.

FIG. 12 is a flowchart diagram illustrating the separation method.

FIG. 13 depicts a graphic overlay of alpha curves of five compounds.

FIG. 14 depicts the separation of the five compounds of FIG. 13.

### DETAILED DESCRIPTION

Differential mobility spectrometry (DMS) devices provide the opportunity to achieve isobaric separations prior to the mass spectrometer inlet, however, obtaining optimal separations is non-trivial. A typical infusion-based procedure involves setting a separation voltage (SV) value (frequently the maximum or a value near the maximum) and ramping the compensation voltage (CoV) to look for separation. While this method can be successful when done carefully, there is no guarantee that the selected SV is best for the separation. In addition, current tuning methods for compounds typically acquire CoV ramps at various SV and select the CoV that provides the maximum signal, regardless of the separation that results.

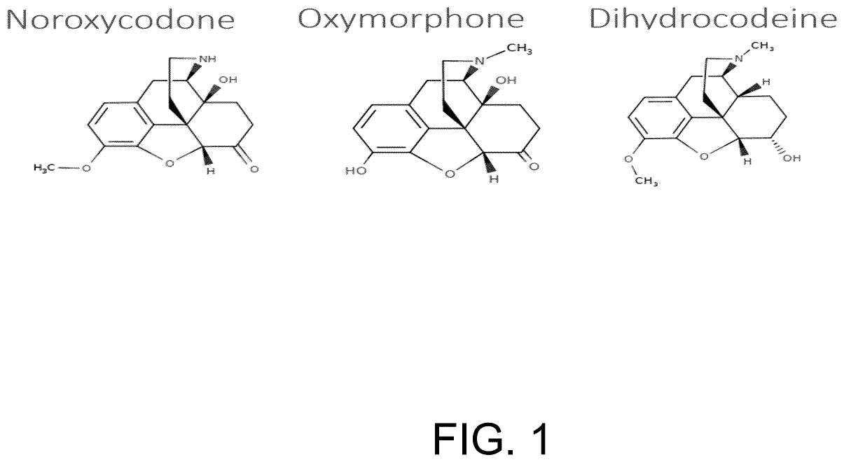

FIG. 1 depicts the structures of three isobaric species. The structural differences for three opioid isobars shown in FIG. 1, i.e., noroxycodone, oxymorphone, and dihydrocodeine, are quite subtle. Even though a specific chemical modifier might be added to the transport gas of a DMS-MS system to facilitate the isobaric separation, achieving isobaric separation of these three opioid isobars is still a challenge. Therefore, there is a need for an easier method of optimizing DMS parameters to ensure the best possible separation is achieved.

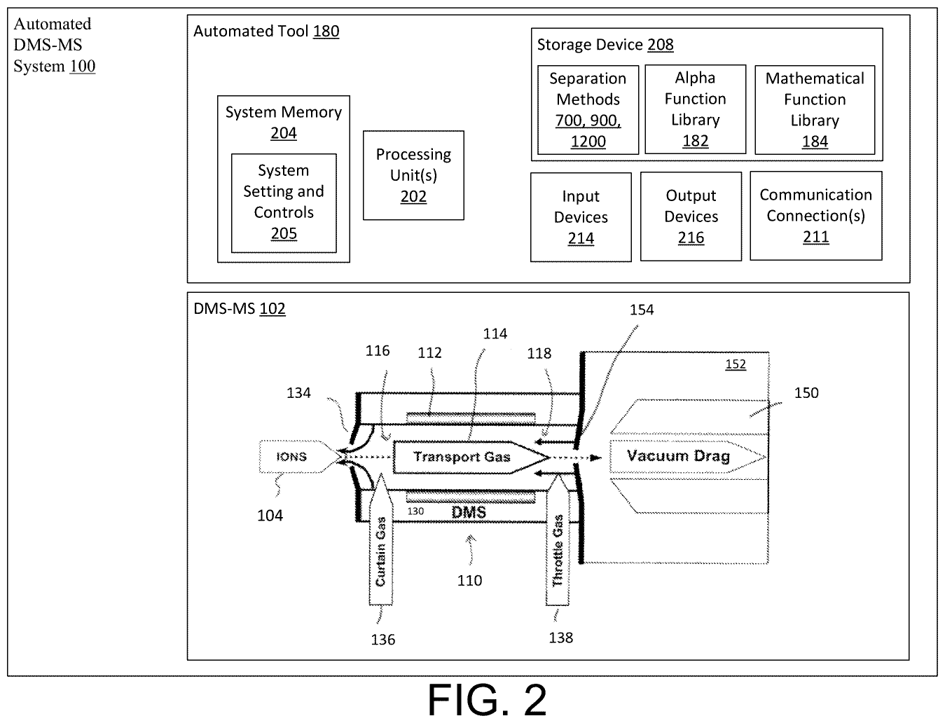

In general, automated methods are provided to determine the best separation conditions for two or more compounds by running a series of defined experiments and conducting a curve fitting of the data to determine the best conditions for separation. An overview of the automated methods is provided in the next two paragraphs, and details of the automated methods will be described in detail with reference to FIGS. 2-14.

A first method involves using a curve fitting method to determine the alpha curves for compounds of interest and then comparing them to determine the separation field that will provide the best possible separation. The method involves infusing a first compound and using an automated optimization tool. The optimization tool first sets a defined set of DMS conditions and then conducts a series of CoV ramps taken at specific SV values for the first compound. The data from the CoV ramps is used to calculate the alpha function for the first compound. The steps are then repeated for a second compound to calculate an alpha function for the second compound. The optimization tool then subtracts the two alpha functions to generate a “difference” function. The optimization tool determines the separation field value that provides the global maximum in an absolute value of the difference function and selects this as the separation field value that provides the best possible separation for the first compound and the second compound. With this method, the selected conditions do not necessarily correspond to one of the initially defined experiments. The automated optimization tool can also store and save alpha curves generated in this manner to build an alpha function library. Once the library data is generated, it is trivial for the automated optimization tool to determine if it is possible to separate two compounds and what would be the best conditions. This method can be extended to separations in the presence of chemical modifiers and under various clustering conditions.

A second method involves running the CoV ramps to determine optimal CoV values at a range of different SV values and then fitting the SV/CoV optima to obtain a mathematical function for two compounds. Subtracting the two different mathematical functions to generate a “difference” function and selecting the separation field value that provides the maximum difference. The remaining aspects of the second method are like those of the first method.

In summary, there are no current automated methods designed to maximize the separation of two compounds, especially in the context of isobaric separations. The automated methods provided in this disclosure can ensure that an automated tool will always select the best separation conditions for samples having two or more compounds. Therefore, the separation process is greatly simplified, and users can separate compounds that they have been previously unsuccessful at separating. The automation of the whole system may also significantly reduce test cycles, labor required, and human errors.

FIG. 2 depicts a schematic view of an automated DMS-MS system 100 in accordance with some aspects of the disclosure. In the example of FIG. 2, the automated DMS-MS system 100 includes, among other things, a DMS-MS 102 and an automated tool 180. Generally, the DMS-MS 102 performs gas-phase ion sample separation, detection, and analysis by continuously transmitting ions-of-interest while filtering out unwanted species, whereas the automated tool 180 facilitates the automated methods of operating the DMS-MS 102 to separate compounds.

The DMS-MS 102 generally comprises a DMS 110 in fluid communication with a first vacuum lens element of a mass spectrometer 150. It should be noted that the DMS-MS 102 represents only one possible configuration for use in accordance with various aspects of the systems, devices, and methods described herein.

The DMS 110 can have a variety of configurations, but is generally configured to resolve ions 104 based on their mobility through a fixed or variable electric field (whereas the mass spectrometer 150 analyzes ions based on their mass-to-charge ratios). In the DMS 110, radio frequency (RF) voltages, often referred to as separation voltages (SV), can be applied across the drift tube in a direction perpendicular to that of a drift gas flow. Ions of a given species tend to migrate radially away from the axis of the transport chamber by a characteristic amount during each cycle of the RF waveform due to differences in mobility during the high field and low field portions. A DC potential, commonly referred to as a compensation voltage (CoV), applied to the DMS cell provides a counterbalancing electrostatic force to that of the SV. The CoV can be tuned so as to preferentially prevent the drift of a species of ion of interest. Depending on the application, the CoV can be set to a fixed value to pass only ion species with a particular differential mobility while the remaining species of ions drift toward the electrodes and are neutralized. Alternatively in another application, if the CoV is scanned for a fixed SV as a sample is introduced continuously into the DMS 110, a mobility spectrum can be produced as the DMS 110 transmits ions of different differential mobilities.

In the example depicted in FIG. 2, the DMS 110 is contained within a curtain chamber 130 that is defined by a curtain plate or boundary member 134 and is supplied with a curtain gas 136 from a curtain gas supply (not shown). As shown in FIG. 2, the exemplary DMS 110 includes a pair of opposed electrode plates 112 that surround a transport gas 114 that drifts from an inlet 116 of the DMS 110 to an outlet 118 of the DMS 110. The outlet 118 of the DMS 110 releases the transport gas 114 into an inlet 154 of a vacuum chamber 152 containing the mass spectrometer 150. A throttle gas 138 can additionally be supplied at the outlet 118 of the DMS 110 so as to modify the flow rate of transport gas 114 through the DMS 110.

In accordance with certain aspects of the disclosure, the curtain gas 136 and throttle gas 138 can be set to flow rates determined by a flow controller and valves so as to alter the drift time of ions within the DMS 110. Each of the curtain gas 136 and throttle gas 138 supplies can provide the same or different pure or mixed composition gas to the curtain chamber 130. By way of non-limiting example, the curtain gas 136 can be air, O₂, He, N₂, CO₂, other inert gases, or any combinations thereof. The pressure of the curtain chamber 130 can be maintained, for example, at or near atmospheric pressure (i.e., 760 Torr). Additionally, the DMS 110 can include a chemical modifier supply (not shown) for supplying a chemical modifier and/or reagent to the curtain gas 136 and/or the throttle gas 138. It should be noted that the modifier supply can be a reservoir of a solid, liquid, or gas through which the curtain gas 136 is delivered to the curtain chamber 130. By way of example, the curtain gas 136 can be bubbled through a liquid modifier supply. Alternatively, a modifier liquid or gas can be metered into the curtain gas 136, for example, through an LC pump, syringe pump, or other dispensing devices for dispensing the modifier into the curtain gas at a known rate. For example, the modifier can be introduced using a pump so as to provide a selected concentration of the modifier in the curtain gas. The modifier supply can provide any modifier including, by way of non-limiting example, water, methanol, acetone, isopropanol, methylene chloride, methylene bromide, dimethyl sulfoxide, acetonitrile, any other liquid species capable of clustering with ions of interest, or any combination thereof.

The chemical modifier can interact with the ionized analytes (e.g., via a charged site in the compound) such that various analytes differentially interact with the modifier during the high and low field portions of the SV, thereby affecting the CoV needed to counterbalance a given SV. In some cases, this can increase the separation between analytes. Specifically, the chemical modifier can interact with the charged site in the isomeric molecules depending on the location of functional groups (e.g., electron donating group, electron withdrawing group). Examples of steric effects include, for example, the blockage of a charged site within the analyte, thereby altering the analytes drift through the DMS 110 during the high and/or low portions of the SV. As further disclosed herein, the identity of an analyte's functional group and its location can affect the interaction of a chemical modifier with the compound in the DMS 110, thus also affecting CoV.

Ions 104 (e.g., ionized analytes) can be generated by an ion source (not shown) and emitted into the curtain chamber 130 via curtain chamber inlet. The ion source can be virtually any ion source known in the art, including for example, an electrospray ionization (ESI) source. The flow of the curtain gas 136 in the curtain chamber 130 (e.g., approximately 760 Torr) can provide both a curtain gas outflow out of curtain chamber inlet, as well as a curtain gas inflow into the DMS 110, which inflow becomes the transport gas 114 that carries the ions 104 through the DMS 110 and into the mass spectrometer 150 contained within the vacuum chamber 152, which can be maintained at a much lower pressure than the curtain chamber 130. By way of non-limiting example, the vacuum chamber 152 can be maintained at a pressure lower than that of the curtain chamber 130 (e.g., by a vacuum pump) so as to drag the transport gas 114 and ions 104 entrained therein into the inlet 154 of the mass spectrometer 150. Though not shown, the sample(s) containing the analytes of interest can be delivered to the ion source 104 from a variety of sample sources, including through direct injection, pumping from a reservoir containing a fluid sample, flow injection analysis, and via a liquid chromatography (LC) column, by way of non-limiting examples.

The DMS-MS 102 may additionally include one or more additional mass analyzer elements downstream from vacuum chamber 152. Ions 104 can be transported through vacuum chamber 152 and through one or more additional differentially pumped vacuum stages containing one or more mass analyzer elements. For instance, in one embodiment, a triple quadrupole mass spectrometer may comprise three differentially pumped vacuum stages, including a first stage maintained at a pressure of approximately 2.3 Torr, a second stage maintained at a pressure of approximately 6 mTorr, and a third stage maintained at a pressure of approximately 10⁻⁵ Torr. The third vacuum stage can contain a detector, as well as two quadrupole mass analyzers with a collision cell located between them. It should be noted that there may be a number of other ion optical elements in the system. Alternatively, a detector (e.g., a Faraday cup or other ion current measuring device) effective to detect the ions 104 transmitted by the DMS 110 can be disposed of directly at the outlet of the DMS 110. It should be noted that the mass spectrometer 150 employed could take the form of a quadrupole mass spectrometer, triple quadrupole mass spectrometer, time-of-flight mass spectrometer, FT-ICR mass spectrometer, or Orbitrap mass spectrometer, all by way of non-limiting example.

As mentioned above, the automated tool 180 facilitates the automated methods of operating the DMS-MS 102 to separate compounds. In the example of FIG. 2, the automated tool 180 includes, among other things, one or more processing units 202, a system memory 204, a storage device 208, input devices 214, output devices 216, and communication connections 211. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smartphones, network PCs, minicomputers, mainframe computers, tablets, distributed computing environments that include any of the above systems or devices, and the like.

Depending on the exact configuration and type of computing device, the system memory 204 can be volatile (such as RAM), non-volatile (such as ROM, flash memory, etc.), or some combination of the two. The system memory 204 may include system setting and controls 205 for operating the automated DMS-MS 102. The storage device 208 may include, but not limited to, magnetic or optical disks or tape. In some embodiments, the input devices 214 may include touch screens, keyboard, mouse, pen, voice input, and the like. In some embodiments, the output devices 216 may include a display, speakers, printer, and the like. In some embodiments, the communication connections 211 may include local area network (LAN), wide area network (WAN), pear-to-pear (P2P) network, Bluetooth, RF, and the like.

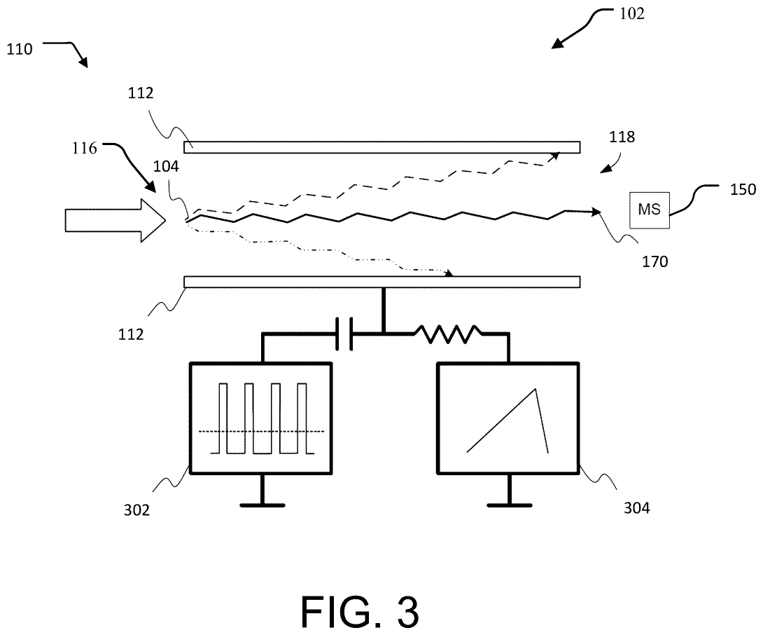

The storage device 208 includes, among other things, an alpha function library 182, a mathematical function library 184, and separation methods 700, 900, 1200. The one or more processing units 202 and the system memory can access the alpha function library 182, the mathematical function library 184, and the separation methods 700, 900, 1200 as necessary. The separation methods 700, 900, 1200 are prestored separation methods to separate multiple compounds. The alpha function library 182 is a library saving data of various alpha functions of different compounds. The mathematical function library 184 is a library saving data of various mathematical functions of different compounds. Details of the separation methods 700, 900, 1200, details of the alpha function library 182, and details of the mathematical function library 184 will be described below with reference to FIGS. 3-14.

The automated tool 180 may also include at least some form of computer readable media. Computer readable media can be any available media that can be accessed by the one or more processing units 202 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The automated tool 180 can be in the form of a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by the one or more processing units 202 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media.

FIG. 3 is a schematic diagram of the DMS 110 of FIG. 2. As explained above, the DMS 110 includes the pair of opposed electrode plates 112. Radio frequency (RF) voltage source 302 applies an RF separation voltage (SV) between the pair of opposed electrode plates 112, and direct current (DC) voltage source 304 applies a DC compensation voltage (CoV) between the pair of opposed electrode plates 112. Ions 104 enter the DMS 110 in a transport gas. Unlike traditional ion mobility, the ions 104 are not separated in time as they traverse the device. Instead, the ions 104 are separated in trajectory based on the difference in their mobility between the high field and low field portions of the RF voltage applied by the RF voltage source 302. The high field is applied between the pair of opposed electrode plates 112 for a short period of time, and then a low field is applied with the opposite polarity for a longer period of time. Any difference between the low-field and high-field mobility of an ion of a compound of interest causes it to migrate towards one of the opposed electrode plates 112. The ion 104 is steered back towards the center-line of the device by the application of a second voltage offset, namely the CoV of the DC voltage source 304, a compound-specific parameter that can be used to filter out other ions selectively. Rapid switching of the CoV allows the DMS 110 to monitor many different compounds concurrently. Ions 170 selected by the combination of SV and CoV leave the DMS 110 through the outlet 118 to the remainder of the DMS-MS 102. The DMS 110 is located between an ion source device (not shown) and the remainder of the DMS-MS 102, for example.

As illustrated in FIG. 3, the component of the electric field (E⊥(t)) that is perpendicular to the pair of opposed electrode plates 112 is given by the equation below:

$${E}_{⊥} ( t ) = S ( t ) + C$$

where S(t) is the time-varying separation field and C is the compensation field. Accordingly, the ion drift speed perpendicular to the DMS plates, which is the product of ion mobility and electric field, is given by the equation below:

$${v}_{⊥} ( t ) = K ( E ) {E}_{⊥} ( t ) = K ( 0 ) [ 1 + α ( E ( t ) ) ] [ S ( t ) + C ]$$

where alpha (α) is the normalized difference between the high and low field mobility, v⊥(t) is the drift speed perpendicular to the pair of opposed electrode plates 112, K(E) is the field-dependent ion mobility, K(0) is the low field ion mobility constant, and E⊥(t) is the electric field. The condition for transmission in DMS is that the ion drift speed v⊥(t) is zero. As such, the equation immediately above is simplified to the equation below:

$$〈 S 〉 + 〈 C 〉 + 〈 S α 〉 + 〈 C α 〉 = 0$$

where the triangular brackets denote the average over one cycle of the waveform. The waveform of SV has an average of zero over one cycle. In other words, [symbol] S [symbol] 32 0. On the other hand, [symbol] C [symbol] is a constant. Therefore, the compensation field can be determined from the equation below:

$$C = \frac{- 〈 S α 〉}{1 + 〈 α 〉}$$

Therefore, if data measuring the compensation field (C) at various separation fields (S) are collected, alpha can be calculated accordingly. On the other hand, if the alpha curve for a given ion is known, the compensation voltage (CoV) can be calculated with any separation field (S) or gap height of the pair of opposed electrode plates 112.

In order to use the equation immediately above for the compensation field, [symbol] α [symbol] and [symbol] Sα [symbol] must be evaluated at each point in the digitized waveform for each experimentally determined SV and CoV. On the other hand, α is a function of (S(t)+C), as shown in the equation below:

$$α = α ( {E}_{⊥} ( t ) ) = α ( S ( t ) + C )$$

To eliminate C from the right hand side of the equation immediately above, the alpha function is expanded about S in a Taylor series as shown in the equation below:

$$α ( S + C ) = α ( S ) + {α}^{′} ( S ) C + \frac{1}{2 !} {α}^{″} ( S ) {C}^{2} +$$

where

$${α}^{′} = \frac{\partial α}{\partial {E}_{⊥}} .$$

If only the first two terms in the Taylor expansion are kept, C is calculated by the equation below:

$$C = \frac{- 〈 S α ( S ) 〉 - C ) 〈 S {α}^{′} ( S ) 〉}{1 + 〈 α ( S ) 〉 + C 〈 {α}^{′} ( S ) 〉}$$

Re-arrangement of the above equation and elimination of the second-order term in C yields a first-order approximation for the compensation field as shown in the equation below:

$$C = \frac{- 〈 S α ( S ) 〉}{1 + 〈 α ( S ) 〉 + 〈 S {α}^{′} ( S ) 〉}$$

where the terms [symbol] α [symbol] , [symbol] Sα [symbol] and [symbol] Sα′(S) [symbol] can be calculated from the three equations below:

$$〈 α ( S ) 〉 = \frac{1}{T} {\int }_{0}^{T} α ( S ( t ) ) dt$$

$$〈 S α ( S ) 〉 = \frac{1}{T} {\int }_{0}^{T} S ( t ) α ( S ( t ) ) dt$$

$$〈 S {α}^{′} ( S ) 〉 = \frac{1}{T} {\int }_{0}^{T} S ( t ) {α}^{′} ( S ( t ) ) dt$$

The mobility dependence a can be expanded as a function of the separation field (expressed in Townsends) in the equation below:

$$α ( S ) = {α}_{2} {S}^{2} + {α}_{4} {S}^{4} + {α}_{6} {S}^{6} + {α}_{8} {S}^{8} +$$

The coefficients (α₂, α₄, α₆, α₈, etc.) are adjusted to obtain an alpha function that gives the best fit of experimental data to the values of the compensation field (C) reconstructed from Taylor expansions of the general expression for the compensation field (C).

The compensation field (C) can be converted to CoV by multiplying by the gap height between the pair of opposed electrode plates 112 and gas number density and dividing by 1×10¹⁷ to convert from Townsend units to voltage.

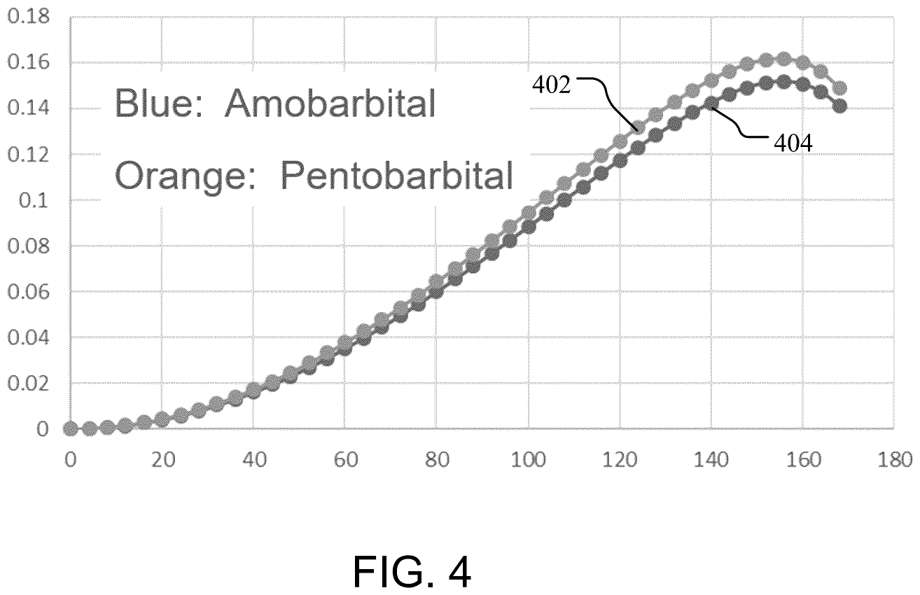

FIG. 4 depicts alpha curves for two isomers, namely pentobarbital and amobarbital. Pentobarbital and amobarbital are molecules with identical molecular formulas, namely same number of atoms of each element, but distinct arrangements of atoms in space. A mixture of two isomers, pentobarbital and amobarbital, are desired to be separated by the DMS-MS 102. The molecular structures of pentobarbital and amobarbital differ only in the location of a methyl group (CH₃) on the molecule. As a result, pentobarbital and amobarbital are not clearly differentiable by mass spectrometry alone. These compounds are difficult for a DMS to separate when using nitrogen transport gas without chemical modifiers, and there is considerable overlap of the alpha curves (also referred to as “alpha functions”) generated in the absence of chemical modifiers. When acetonitrile chemical modifier is added to the transport gas, there is some differentiation of the alpha curve 402 (corresponding to pentobarbital) and the alpha curve 404 (corresponding to amobarbital) as shown in FIG. 4.

However, the difference is small. As mentioned above, the conventional method is setting a separation voltage (SV) value which is frequently the maximum or a value near the maximum. As shown in FIG. 4, the conventional method fails to capture the optimal separations which can be achieved with a separation field on the order of 140-150 Td. When the separation field was set to the recommended value on the order of 140-150 Td, baseline separation can be achieved for these difficult to separate isomers, namely pentobarbital and amobarbital.

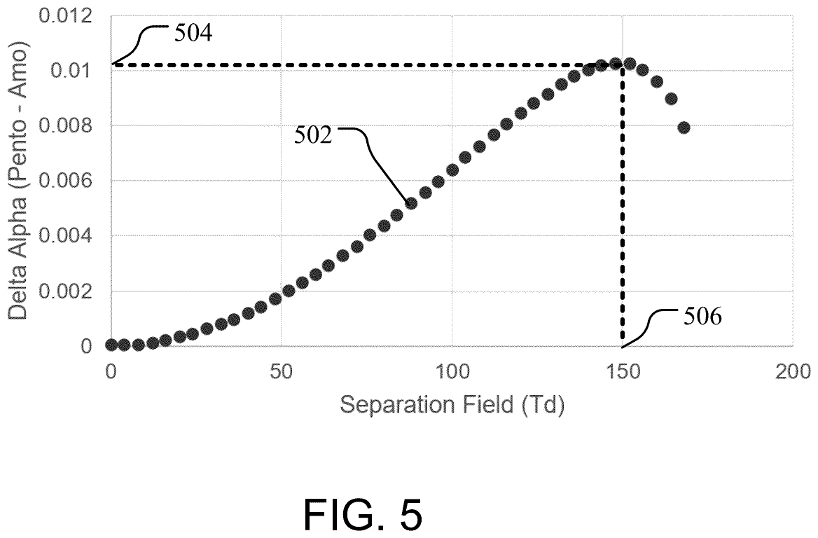

FIG. 5 depicts a difference curve 502 between the pentobarbital alpha curve 402 and the amobarbital alpha curve 404 of FIG. 4. The difference curve (also referred to as “difference function”) 502 is determined by subtracting the amobarbital alpha curve 404 from the pentobarbital alpha curve 402. Once the difference curve 502 is determined, a separation field value 506 (also referred to as “optimal separation field value” 506) associated with the optimal separation can be determined by determining the separation field corresponding to the global maximum of an absolute value of the difference curve 504.

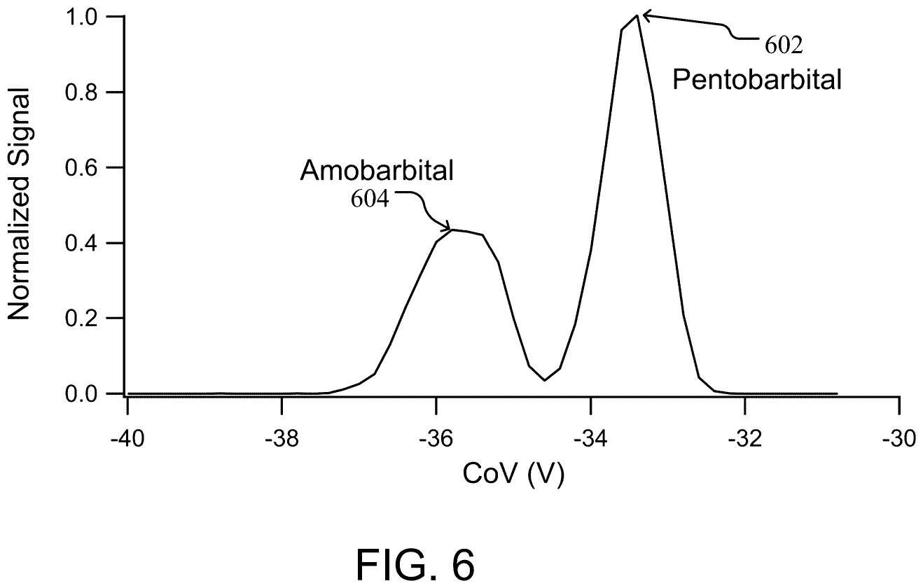

FIG. 6 depicts the separation of amobarbital and pentobarbital. After selecting the separation field value to be the optimal separation field value, the detected ion intensity (after normalization) is generated by ramping the CoV over a range of CoV values. As shown in FIG. 6, there are two peaks 602 and 604. The peak 602 at about −33.5 V corresponds to pentobarbital, whereas the peak 604 at about −35.8V corresponds to amobarbital. As such, the peaks 602 and 604 for pentobarbital and amobarbital, respectively, appear at different CoV values, thus providing better separation of these two compounds than using conventional separation methods.

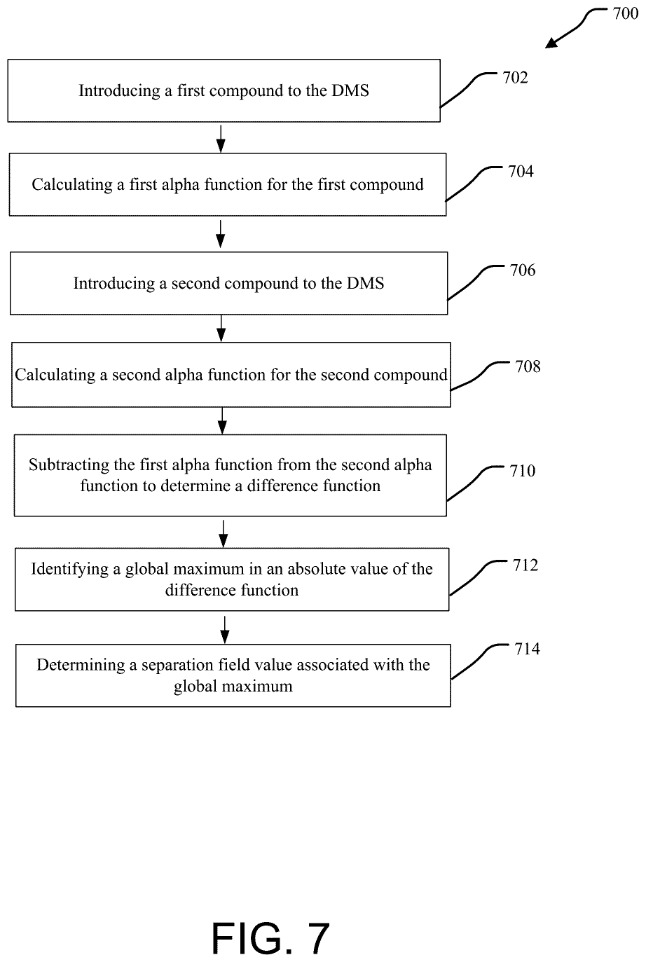

FIG. 7 is a flowchart diagram illustrating a separation method 700. Certain components utilized in the method 700 and described elsewhere herein are provided for context and illustrative purposes only. Other similar systems to those described herein may also be utilized to perform the method 700, as well as other methods depicted and described herein. The separation method 700 begins with operation 702, introducing a first compound (e.g., pentobarbital) to the DMS 110. The first compound may be ionized prior to introducing the first compound to the DMS 110. Ionizing the first compound may include introducing with the first compound the DMS transport gas 114 comprising at least one of nitrogen and nitrogen with a chemical modifier. In some embodiments, the composition of the transport gas 114 is set prior to ionizing the first compound. Ionizing the first compound may include introducing the first compound discretely with the transport gas 114 comprising nitrogen, a first amount of nitrogen with a first amount of the chemical modifier, and a second amount of nitrogen with a second amount of the chemical modifier.

Flow continues to operation 704, a first alpha function (e.g., 402 of FIG. 4) is calculated for the first compound. This operation 704 may include: setting a separation voltage (SV) of the DMS 110; adjusting a compensation voltage (CoV) of the DMS 110; and while adjusting the CoV, concurrently monitoring an analytical signal (e.g., a mass spectrometer signal intensity) from the MS 150; and based at least in part on monitoring the analytical signal, generating a sample plot for each of a plurality of different separation voltage settings of the DMS 110. In some embodiments, each sample plot includes a mass spectrometer signal intensity versus the CoV. In some embodiments, the operation 704 may further include transforming the sample plots into the first alpha function (e.g., 402 of FIG. 4). The first alpha function may be stored in the alpha function library 182 for future use if needed.

Flow continues to operation 706, introducing a second compound (e.g., amobarbital) to the DMS 110. Likewise, the second compound may be ionized prior to introducing the second compound to the DMS 110. Ionizing the second compound may include introducing with the second compound the DMS transport gas 114 comprising at least one of nitrogen and nitrogen with a chemical modifier. In some embodiments, the composition of the transport gas 114 is set prior to ionizing the second compound. Ionizing the second compound may include introducing the second compound discretely with the transport gas 114 comprising nitrogen, a first amount of nitrogen with a first amount of the chemical modifier, and a second amount of nitrogen with a second amount of the chemical modifier.

Flow continues to operation 708, a second alpha function (e.g., 404 of FIG. 4) is calculated for the second compound. Likewise, this operation 708 may include: setting a separation voltage (SV) of the DMS 110; adjusting a compensation voltage (CoV) of the DMS 110; and while adjusting the CoV, concurrently monitoring an analytical signal (e.g., a mass spectrometer signal intensity) from the MS 150; and based at least in part on monitoring the analytical signal, generating a sample plot for each of a plurality of different separation voltage settings of the DMS 110. In some embodiments, each sample plot includes a mass spectrometer signal intensity versus the CoV. In some embodiments, the operation 708 may further include transforming the sample plots into the second alpha function (e.g., 404 of FIG. 4). Similarly, the first alpha function may be stored in the alpha function library 182 for future use if needed. The alpha function library 182 will accumulate various alpha functions for various compounds over time. A large pool of various alpha functions may further boost the efficiency of the automated DMS-MS system 100 of FIG. 2.

Flow continues to operation 710, subtracting the first alpha function from the second alpha function to determine a difference function. As a result, a difference function (e.g., 502 of FIG. 5) is generated. Flow continues to operation 712, a global maximum (e.g., 504 of FIG. 5) in an absolute value of the difference function is identified. In other words, the maximum in the difference function that is achievable is identified. Flow continues to operation 714, determining a separation field value associated with the global maximum, which is also referred to as the optimal separation field value (e.g., 506 of FIG. 5). In other words, the optimal separation field is determined.

Alternatively, a range of separation field may be determined based on the first alpha function and the second alpha function. In one embodiment, the range of separation field may be determined based on an absolute value of the difference function (e.g., the one determined at operation 710). In one example, the range of separation field covers the separation field value associated with the global maximum (e.g., the one determined at operation 714).

Alternatively, operation parameters of the DMS 110 are determined to achieve sufficient separation of the first compound and the second compound, based on the first alpha function (e.g., 402 of FIG. 4) and the second alpha function (e.g., 404 of FIG. 4). In one example, the operation parameters of the DMS 110 include, among other things, a range of SV values. When the DMS 110 operates with the range of SV values, the absolute values of the difference between the first alpha function and the second alpha function are equal to or larger than a threshold alpha function difference.

The separation method 700 may further include: setting a test separation field of the DMS 100 to the separation field value associated with the global maximum; and introducing a test sample to the DMS 110. The test sample includes at least one of the first compound and the second compound. As such, the test separation field of the DMS 110 is selected as the optimal separation field (e.g., 506 of FIG. 5) to achieve the best separation of the first compound and the second compound.

In some embodiments, the first alpha function for the first compound and the second alpha function for the second compound may be retrieved from the alpha function library 182, instead of being calculated. Operation parameters of the DMS 110 are then determined to achieve sufficient separation of the first compound and the second compound, based on the first alpha function and the second alpha function.

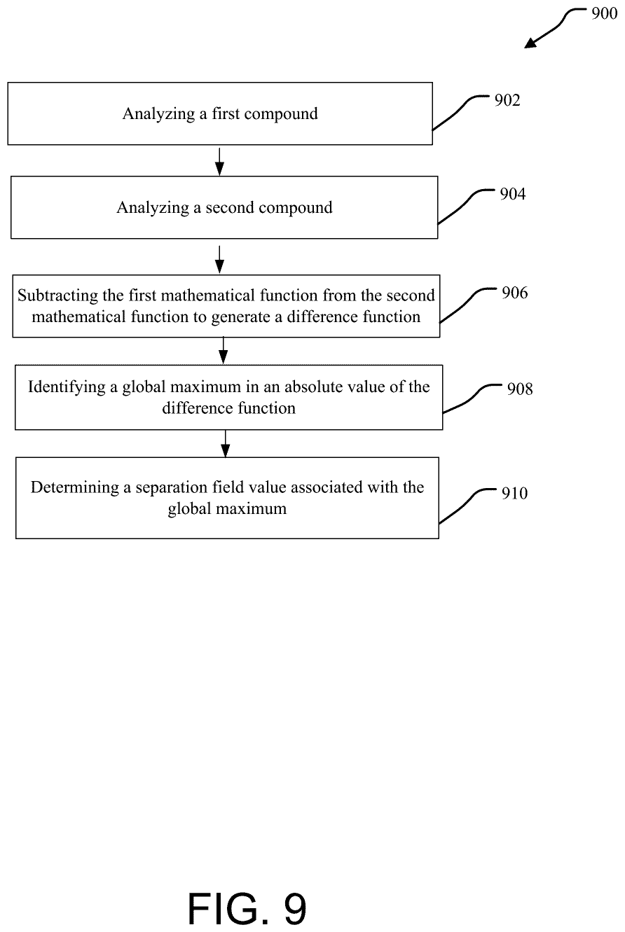

On the other hand, another separation method 900 in FIG. 9 can be implemented by the automated DMS-MS system 100. The separation method 900 involves running the CoV ramps to determine optimal CoV values at a range of different SV values and then fitting the SV/CoV optima to obtain a mathematical function for two compounds. The two different mathematical functions are subtracted to generate a “difference” function, and the separation field value that provides the maximum difference is determined.

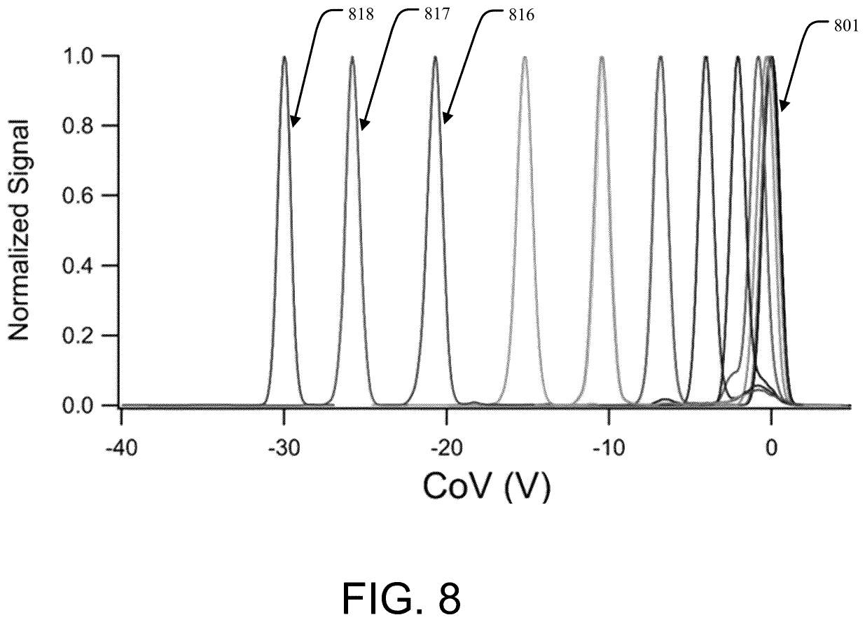

FIG. 8 depicts a graphic overlay of a series of CoV ramps that are acquired at a series of different SV values. As shown in FIG. 8, a range of different SV values are selected. In the example of FIG. 8, eighteen SV values (0 V, 250 V, 500 V, 750 V, . . . , 3750 V, 4000 V, 4250 V, in increments of 250 V) are selected. For each of the eighteen SV values, CoV are ramped while monitoring an analytical signal from the MS 150. As a result, there are eighteen curves of analytical signal versus CoV. For instance, the curve 801 corresponds to the curve with an SV value of zero; the curve 816 corresponds to the curve with an SV value of 3750 V; the curve 817 corresponds to the curve with an SV value of 4000 V; the curve 818 corresponds to the curve with an SV value of 4250 V. For each of the eighteen curves, a CoV optimum is determined. The CoV optimum is the CoV value that corresponds to the maximum analytical signal.

By fitting the SV and CoV optima, a mathematical function for each of a first compound and a second compound can be generated. The two different mathematical functions for the first compound and the second compound are subtracted to generate a difference function. Similar to the process related to FIG. 5, the separation field value that provides the maximum difference can be determined based on the difference function.

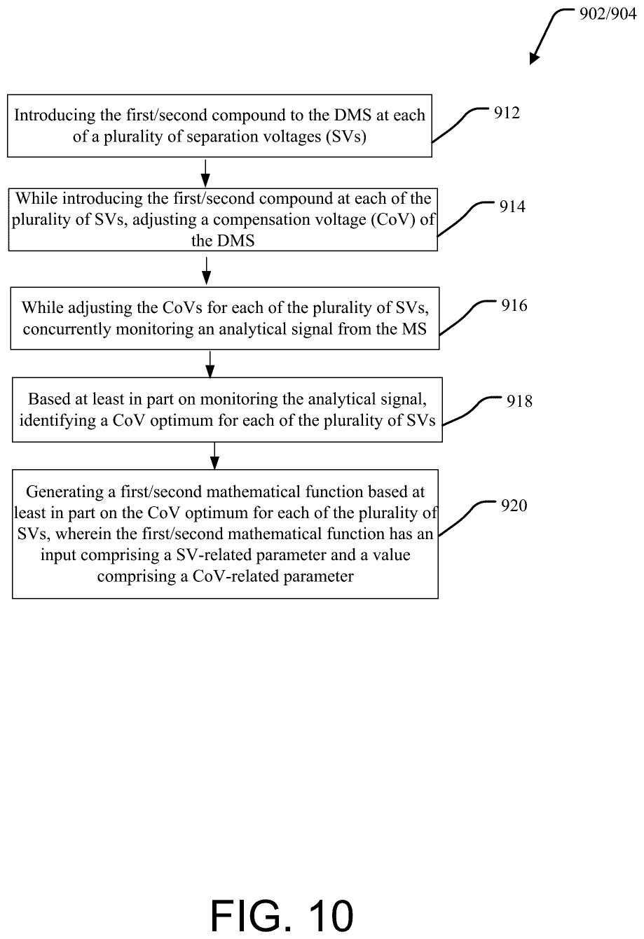

The separation method 900 of FIG. 9 begins with operation 902, analyzing a first compound. The flow continues to operation 904, analyzing a second compound. The operation 902 and the operation 904 are further illustrated in FIG. 10. Each of the operation 902 and the operation 904 includes operations 912, 914, 916, 918, and 920. Take the operation 902 as an example. The operation 904 is not repeated for simplicity.

The operation 902 begins with the operation 912, introducing the first compound to the DMS 110 at each of a plurality of separation voltages (SVs) (e.g., eighteen SVs of FIG. 8). The operation 902 continues to the operation 914, adjusting a compensation voltage (CoV) of the DMS while introducing the first compound at each of the plurality of SVs. The operation 902 continues to the operation 916, concurrently monitoring an analytical signal (e.g., a mass spectrometer signal intensity) from the MS 150, while adjusting the CoVs for each of the plurality of SVs. The operation 902 continues to the operation 918, identifying a CoV optimum for each of the plurality of SVs, based at least in part on monitoring the analytical signal. The operation 902 continues to the operation 920, generating a first mathematical function based at least in part on the CoV optima for each of the plurality of SVs. The first mathematical function has an input comprising a SV-related parameter and a value comprising a CoV-related parameter. The SV-related parameter is one of the SV and a separation field, whereas the CoV-related parameter is one of the CoV and a compensation field. In other words, all four permutations of the SV-related parameter and the CoV-related parameter are within the scope of the disclosure. As such, both the first mathematical function and the second mathematical function are generated at the operation 902 and 904, respectively.

The first and second mathematical functions may be stored in the mathematical function library 184 for future use if needed. The mathematical function library 184 will accumulate various mathematical functions for various compounds over time. A large pool of various mathematical functions, assuming that they are tested on the same automated DMS-MS system 100 of FIG. 2, may further boost the efficiency of the automated DMS-MS system 100.

The method 900 continues to operation 906, subtracting the first mathematical function from the second mathematical function to generate a difference function. The method 900 continues to operation 908, identifying a global maximum in an absolute value of the difference function, which is similar to the operation 712 of FIG. 7. The method 900 continues to operation 910, determining a separation field value associated with the global maximum, which is similar to the operation 714 of FIG. 7.

Alternatively, a range of separation field may be determined based on the first mathematical function and the second mathematical function. In one embodiment, the range of separation field may be determined based on an absolute value of the difference function (e.g., the one determined at operation 906). In one example, the range of separation field covers the separation field value associated with the global maximum (e.g., the one determined at operation 910).

Alternatively, operation parameters of the DMS 110 are determined to achieve sufficient separation of the first compound and the second compound, based on the first mathematical function and the second mathematical function. In one example, the operation parameters of the DMS 110 include, among other things, a range of SV values. When the DMS 110 operates with the range of SV values, the absolute values of the difference between the first mathematical function and the second mathematical function are equal to or larger than a threshold alpha function difference.

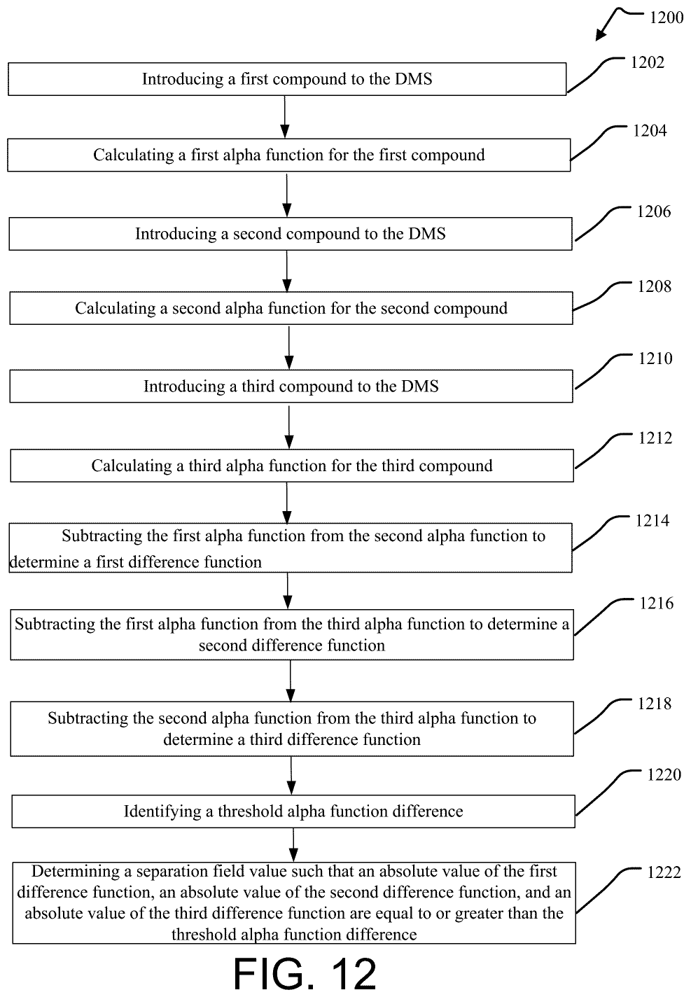

According to another aspect of the disclosure, another separation method 1200 in FIG. 12 can be implemented by the automated DMS-MS system 100. The separation method 1200 involves separating three compounds, namely a first compound, a second compound, and a third compound. The separation method 1200, however, can be applied to separation of more than three compounds. The separation method 1200 differs from the separation method 700 in that it involves determining three difference functions between any two of the three alpha functions and determining a separation field value such that absolute values of three difference functions are equal to or greater than a threshold alpha function difference. In other words, the focus is shifted from a global maximum to a threshold to guarantee an acceptable or sufficient separation between any combination of the three compounds.

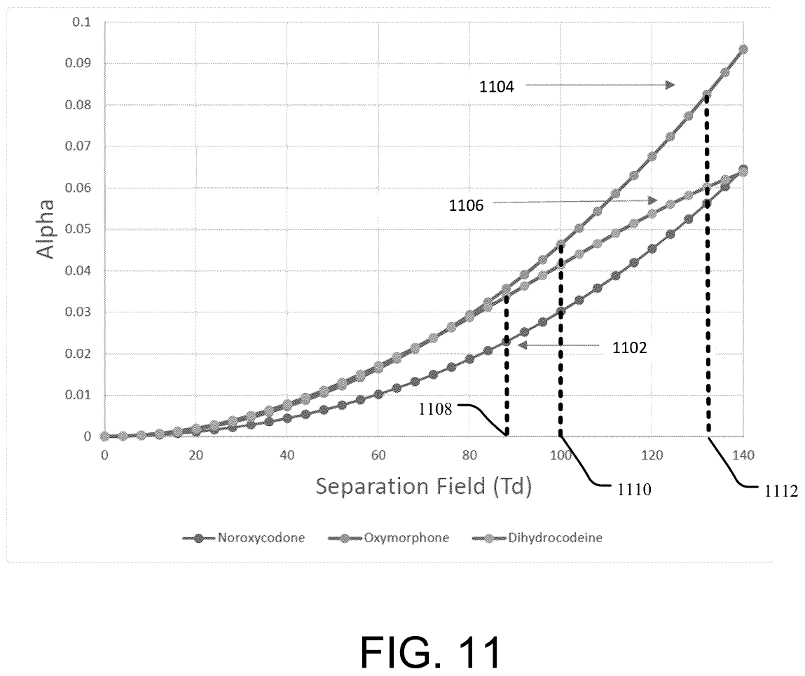

As shown in FIG. 11, the alpha curves 1102, 1104, and 1106 of three compounds, namely noroxycodone, oxymorphone, and dihydrocodeine, are close to each other, making it hard to be separated using conventional methods. For instance, when the alpha curve 1102 of noroxycodone and the alpha curve 1106 of dihydrocodeine has a global maximum of their difference function (i.e., when the separation field is 1108 as shown in FIG. 11), the alpha curve 1104 of oxymorphone and the alpha curve 1106 of dihydrocodeine has a relatively small difference that is below the threshold alpha function difference, making it impractical to separate oxymorphone and dihydrocodeine when the separation field is 1108. By using the separation method 1200, a separation field value, or more likely a range of separation field values, are determined to make sure that absolute values of the three difference functions are equal to or greater than the threshold alpha function difference. In the example of FIG. 11, the range of a separation field values is from the separation field 1110 to the separation field 1112.

Aspects of the separation method 1200 that are similar to those of the separation method 700 are not repeated in detail for simplicity. The separation method 1200 begins with operation 1202, introducing a first compound (e.g., noroxycodone) to the DMS 110. Flow continues to operation 1204, a first alpha function (e.g., 1102 of FIG. 11) is calculated for the first compound. This operation 1204 may include: setting a separation voltage (SV) of the DMS 110; adjusting a compensation voltage (CoV) of the DMS 110; and while adjusting the CoV, concurrently monitoring an analytical signal (e.g., a mass spectrometer signal intensity) from the MS 150; and based at least in part on monitoring the analytical signal, generating a sample plot for each of a plurality of different separation voltage settings of the DMS 110. In some embodiments, each sample plot includes a mass spectrometer signal intensity versus the CoV. In some embodiments, the operation 1204 may further include transforming the sample plots into the first alpha function (e.g., 1102 of FIG. 11).

Flow continues to operation 1206, introducing a second compound (e.g., oxymorphone) to the DMS 110. Flow continues to operation 1208, a second alpha function (e.g., 1104 of FIG. 11) is calculated for the second compound. This operation 1208 may include: setting a separation voltage (SV) of the DMS 110; adjusting a compensation voltage (CoV) of the DMS 110; and while adjusting the CoV, concurrently monitoring an analytical signal (e.g., a mass spectrometer signal intensity) from the MS 150; and based at least in part on monitoring the analytical signal, generating a sample plot for each of a plurality of different separation voltage settings of the DMS 110. In some embodiments, each sample plot includes a mass spectrometer signal intensity versus the CoV. In some embodiments, the operation 1208 may further include transforming the sample plots into the second alpha function (e.g., 1104 of FIG. 11).

Flow continues to operation 1210, introducing a third compound (e.g., dihydrocodeine) to the DMS 110. Flow continues to operation 1212, a third alpha function (e.g., 1106 of FIG. 11) is calculated for the third compound. Likewise, this operation 1212 may include: setting a separation voltage (SV) of the DMS 110; adjusting a compensation voltage (CoV) of the DMS 110; and while adjusting the CoV, concurrently monitoring an analytical signal (e.g., a mass spectrometer signal intensity) from the MS 150; and based at least in part on monitoring the analytical signal, generating a sample plot for each of a plurality of different separation voltage settings of the DMS 110. In some embodiments, each sample plot includes a mass spectrometer signal intensity versus the CoV. In some embodiments, the operation 1212 may further include transforming the sample plots into the third alpha function (e.g., 1106 of FIG. 11).

Flow continues to operation 1214, subtracting the first alpha function from the second alpha function to determine a first difference function. Flow continues to operation 1216, subtracting the first alpha function from the third alpha function to determine a second difference function. Flow continues to operation 1218, subtracting the second alpha function from the third alpha function to determine a third difference function.

Flow continues to operation 1220, identifying a threshold alpha function difference. In some embodiments, the threshold alpha function difference is an absolute alpha function difference sufficient to separate any two of the first compound, the second compound, and the third compound. Flow continues to operation 1222, determining a separation field value (e.g., the separation field 1110, the separation field 1112, or any value therebetween, as shown in FIG. 11) such that an absolute value of the first difference function, an absolute value of the second difference function, and an absolute value of the third difference function are equal to or greater than the threshold alpha function difference.

In summary, a threshold alpha function difference is identified, which is necessary to guarantee separation, and the automated tool 180 of FIG. 2 can determine a range of separation field values to provide absolute values of difference functions not below the threshold alpha function difference. On the other hand, if it is more critical to ensure good separation of two of the three compounds (i.e., the first and second compounds), the automated tool 180 can determine the maximum possible alpha function difference (in an absolute value) while maintaining alpha function differences (in absolute values) above the threshold alpha function difference as to the “less critical” compound (i.e., the third compound).

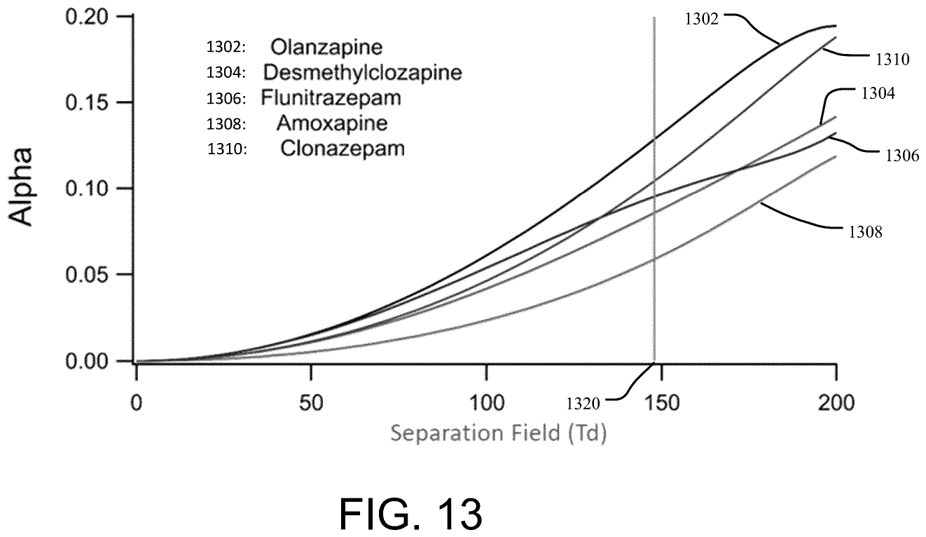

As mentioned above, the separation method 1200 may be applied to the separation of more than three compounds. FIG. 13 depicts a graphic overlay of alpha curves of five compounds. The alpha curve 1302 is the alpha curve of a first compound, namely olanzapine. The alpha curve 1304 is the alpha curve of a second compound, namely desmethylclozapine. The alpha curve 1306 is the alpha curve of a third compound, namely flunitrazepam. The alpha curve 1308 is the alpha curve of a fourth compound, namely amoxapine. The alpha curve 1310 is the alpha curve of a fifth compound, namely clonazepam. When the separation field has a value of 1320 shown in FIG. 13, the five alpha curves 1302, 1304, 1306, 1308, and 1310 have sufficient separation between any two of the five compounds.

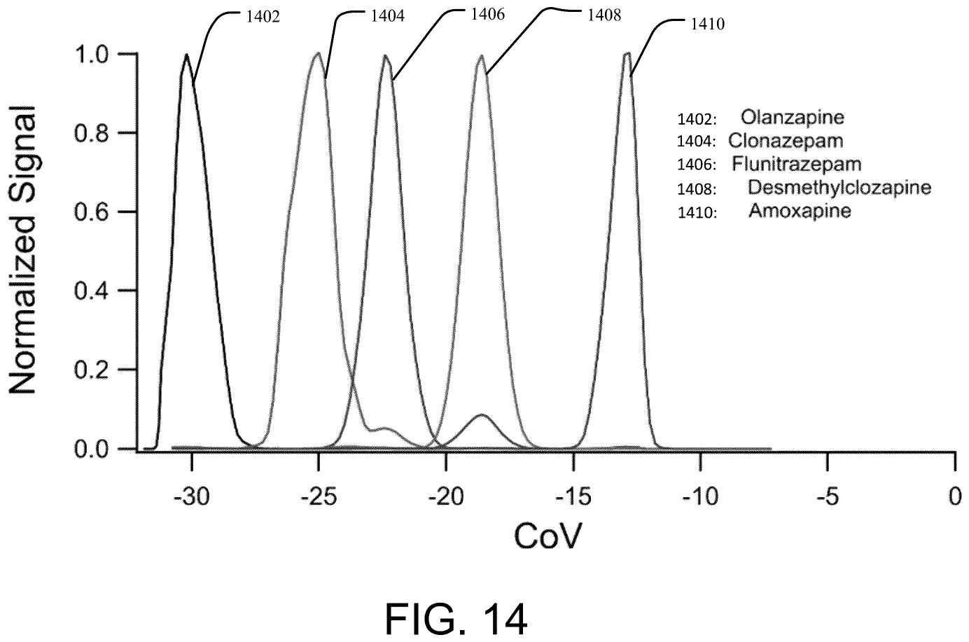

FIG. 14 depicts the separation of the five compounds of FIG. 13. As shown in FIG. 14, after a separation field value in the operation 1222 of FIG. 12, the detected ion intensity curves 1402, 1404, 1406, 1408, and 1410 are generated by ramping the CoV over a range of CoV values. As shown in FIG. 14, the peaks of the five ion intensity curves 1402, 1404, 1406, 1408, and 1410 are distributed over a wide range of CoV values, thus providing better separation of the five compounds than using conventional separation methods.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. An automated method of operating a mass spectrometer (MS) comprising a differential mobility spectrometer (DMS), the automated method comprising:
introducing a first compound to the DMS;
calculating a first alpha function for the first compound;
introducing a second compound to the DMS;
calculating a second alpha function for the second compound; and
determining operation parameters of the DMS to achieve sufficient separation of the first compound and the second compound, based on the first alpha function and the second alpha function.

2. The automated method of claim 1, wherein the operation parameters of the DMS comprise a range of separation field values of the DMS.

3. The automated method of claim 2, wherein when the DMS operates with the range of separation field values, an absolute value of a difference between the first alpha function and the second alpha function is equal to or larger than a threshold alpha function difference.

4. The automated method of claim 2, further comprising:
subtracting the first alpha function from the second alpha function to determine a difference function;
identifying a global maximum in an absolute value of the difference function; and
determining a separation field value associated with the global maximum.

5. The automated method of claim 1, wherein calculating the first alpha function comprises:
setting a separation voltage (SV) of the DMS;
adjusting a compensation voltage (CoV) of the DMS;
while adjusting the CoV, concurrently monitoring an analytical signal from the MS; and
based at least in part on monitoring the analytical signal, generating a sample plot for each of a plurality of different separation voltage settings of the DMS, wherein each sample plot comprises a mass spectrometer signal intensity versus the CoV.

6. The automated method of claim 5, further comprising transforming the sample plots into the first alpha function.

7. The automated method of claim 2, further comprising:
setting a test separation field of the DMS within the range of separation field values; and
introducing a test sample to the DMS, wherein the test sample comprises at least one of the first compound and the second compound.

8. The automated method of claim 1, further comprising ionizing the first compound and the second compound prior to introducing the first compound and the second compound to the DMS.

9. The automated method of claim 8, further comprising introducing with the first compound a DMS transport gas comprising at least one of nitrogen and nitrogen with a chemical modifier.

10. The automated method of claim 8, further comprising setting a composition of the DMS transport gas prior to ionizing the first compound.

11. The automated method of claim 8, further comprising introducing the first compound discretely with the DMS transport gas comprising nitrogen, a first amount of nitrogen with a first amount of the chemical modifier, and a second amount of nitrogen with a second amount of the chemical modifier.

12. An automated method of operating a mass spectrometer (MS) comprising a differential mobility spectrometer (DMS), the automated method comprising:
(a) analyzing a first compound, wherein analyzing a first compound comprises:
introducing the first compound to the DMS at each of a plurality of separation voltages (SVs);
while introducing the first compound at each of the plurality of SVs, adjusting a compensation voltage (CoV) of the DMS;
while adjusting the CoVs for each of the plurality of SVs, concurrently monitoring an analytical signal from the MS;
based at least in part on monitoring the analytical signal, identifying a CoV optimum for each of the plurality of SVs; and
generating a first mathematical function based at least in part on the CoV optimum for each of the plurality of SVs, wherein the first mathematical function has an input comprising a SV-related parameter and a value comprising a CoV-related parameter;
(b) analyzing a second compound, wherein analyzing a second compound comprises:
introducing the second compound to the DMS at each of a plurality of separation voltages (SVs);
while introducing the second compound at each of the plurality of SVs, adjusting a compensation voltage (CoV) of the DMS;
while adjusting the CoVs for each of the plurality of SVs, concurrently monitoring an analytical signal from the MS;
based at least in part on monitoring the analytical signal, identifying a CoV optimum for each of the plurality of SVs; and
generating a second mathematical function based at least in part on the CoV optimum for each of the plurality of SVs, wherein the second mathematical function has an input comprising the SV-related parameter and a value comprising the CoV-related parameter; and
(c) determining operation parameters of the DMS to achieve sufficient separation of the first compound and the second compound, based on the first mathematical function and the second mathematical function.

13. The automated method of claim 12, wherein the operation parameters of the DMS comprise a range of separation field values of the DMS.

14. The automated method of claim 13, wherein when the DMS operates with the range of separation field values, an absolute value of a difference between the first mathematical function and the second mathematical function is equal to or larger than a threshold mathematical function difference.

15. The automated method of claim 13, further comprising:
subtracting the first mathematical function from the second mathematical function to determine a difference function;
identifying a global maximum in an absolute value of the difference function; and
determining a separation field value associated with the global maximum.

16. The automated method of claim 12, wherein the SV-related parameter is one of the SV and a separation field, and wherein the CoV-related parameter is one of the CoV and a compensation field.

17. The automated method of any of claim 13, further comprising:
setting a test separation field of the DMS with the range of separation field values; and
introducing a test sample to the DMS, wherein the test sample comprises at least one of the first compound and the second compound.

18. The automated method of claim 12, further comprising ionizing the first compound and the second compound prior to introducing the first compound and the second compound to the DMS.

19-21. (canceled)

22. An automated method of operating a mass spectrometer (MS) comprising a differential mobility spectrometer (DMS), the automated method comprising:
introducing a first compound to the DMS;
calculating a first alpha function for the first compound;
introducing a second compound to the DMS;
calculating a second alpha function for the second compound;
introducing a third compound to the DMS;
calculating a third alpha function for the third compound;
subtracting the first alpha function from the second alpha function to determine a first difference function;
subtracting the first alpha function from the third alpha function to determine a second difference function;
subtracting the second alpha function from the third alpha function to determine a third difference function;
identifying a threshold alpha function difference; and
determining a separation field value such that an absolute value of the first difference function, an absolute value of the second difference function, and an absolute value of the third difference function are equal to or greater than the threshold alpha function difference.

23. The automated method of claim 22, wherein the threshold alpha function difference is an alpha function difference sufficient to separate any two of the first compound, the second compound, and the third compound.

24-31. (canceled)
